(19) United States
(12) Patent Application Publication
(10) Pub. No.: US 2009/0245847 A1
(43) Pub. Date: Oct. 1, 2009

(54) FIXER DRIVING DEVICE AND FIXER DRIVING METHOD

(75) Inventor: Tokuji Yuda, Ehime (JP)

Correspondence Address: OBLON, SPIVAK, MCCLELLAND MAIER & NEUSTADT, P.C., 1940 DUKE STREET, ALEXANDRIA, VA, 22314, US

(73) Assignee: Harison Toshiba Lighting Corp., Ehime (JP)

(21) Appl. No.: 12/096,720

(22) PCT Filed: Aug. 9, 2006
(86) PCT No.: PCT/JP2006/315764

§ 371 Date: Jun. 30, 2008

(30) Foreign Application Priority Data
Dec. 9, 2005 (JP) 2005-356684

(51) Int. Cl. G03G 15/00

(52) U.S. Cl. 399/88

(57) ABSTRACT

A voltage detecting circuit 21 detects the voltage applied to a load lamp 16, and a current detecting circuit 22 detects the current flowing in a rectifier 14. A controlling section 31 computes the power consumption of the load lamp 16 from the detected voltage and detected current in a half cycle of an alternate current power source voltage using the output of a zero-cross detecting section 15. The controlling section 31 computes the control quantity of PWM control on the basis of computed power consumption. Then, the controlling section 31 fixedly supplies the computed control quantity to a driver circuit 17 in a following half cycle of the alternate current power source voltage. Thereby, the on-duty of a transistor Q1 becomes constant in a half cycle of the alternate current power source voltage, and the current flowing in the rectifier 14 has a sinusoidal waveform. The power factor of the circuit is thus improved, and efficient lamp driving is possible. Together with constant power consumption control, the power factor of the circuit can be improved.

### TECHNICAL FIELD

The present invention relates to a fixer driving device and a fixer driving method suitable for copying machines and the like.

### BACKGROUND ART

Heretofore, in a copying machine or the like, a heater lamp has been used as a heating unit for a fixer. The examples of methods for feeding electric power to the heater lamp include a method for feeding electric power from a commercial alternate current power source using a switch, such as triac. By this method, however, heater temperature is also varied by the variation of alternate current power source voltage applied to a lamp (lamp voltage).

Consequently, in Japanese Patent Application Laid-Open Publication No. 5-216358 (hereafter referred to as Patent Document 1), in order to control heater lamp temperature at a high accuracy, a technique for the PWM control of lamp voltage is disclosed. In this proposal, the on-duty of the PWM control is changed on the basis of values obtained by smoothing lamp voltage. Thereby, stable power consumption can be obtained regardless of the variation of alternate current power source voltage, and the stabilization of heater temperature is intended.

In the meanwhile, in the fixer of a copying machine, the reduction of power consumption in the standby state is required. Therefore, the heater lamp of the fixer is turned off in the standby time, and the heater lamp is turned on when copying is started. In this case, in order that the heater temperature reaches a desired setting temperature in a short time after the heater lamp is turned on, a large electric power must be supplied. However, there is limitation in the maximum current that can be received by the machine from an ordinary power wiring. Therefore, the power factor and efficiency of a circuit must be improved to accelerate the rising of the heater temperature.

In the proposal in Patent Document 1, however, a commercial alternate current power source voltage is rectified by a rectifying circuit, and rectified output (pulsating flow) is PWM-controlled with a switching transistor to apply to a lamp. Specifically, the envelope of the voltage applied to the lamp is a rectangular wave of the pulsating flow, and the amplitude is varied in the cycle of the commercial alternate current power source voltage. Consequently, in Patent Document 1, the PWM control is performed using a value obtained by smoothing the lamp voltage, and the on-duty in the PWM control is varied depending on change in the amplitude of the pulsating-flow-shaped lamp voltage. Therefore, in the proposal in Patent Document 1, a current flowing in the rectifying circuit is changed to have a deformed waveform. Specifically, the power factor of the circuit is lowered, and a relatively long time is required until the heater temperature reaches a desired setting temperature.

The present invention has an object of providing a fixer driving device capable of supplying a stable electric power regardless of a variation of alternate current power source voltage due to high frequency driving and improving the power factor of a circuit and a fixer driving method.

### DISCLOSURE OF INVENTION

### Means for Solving the Problem

A fixer driving device according to the present invention includes a rectifier for rectifying an alternate current power source voltage; a power supplying section for supplying the output of the rectifier to a load lamp; a power consumption detecting section for detecting power consumption of the load lamp; a control quantity computing section for computing control quantity for the power supplying section in order to supply a constant electric power to the load lamp on a basis of the detection result by the power consumption detecting section; and a controlling section for fixedly setting the control quantity computed by the control quantity computing section to the power supplying section in a specified cycle.

A fixer driving method according to the present invention is a fixer driving method for controlling the light from the load lamp by intermittently supplying the output of the rectifier of an alternate current power source voltage to a load lamp with a switching transistor, and by the PWM control of the on-duty of the switching transistor, the method including a step for setting the initial value of the PWM control; a step for acquiring the power consumption of the load lamp; and a step for fixedly setting the control value of the PWM control in a half cycle of the alternate current power source voltage on the basis of power consumption of the load lamp.

### BRIEF DESCRIPTION OF THE DRAWINGS

FIG. 1 is a circuit diagram showing a fixer driving device according to an embodiment of the present invention;

FIG. 2 is a waveform diagram showing the signal waveform of respective sections; and

FIG. 3 is a flowchart for illustrating constant power consumption control in the present embodiment.

### BEST MODE FOR CARRYING OUT THE INVENTION

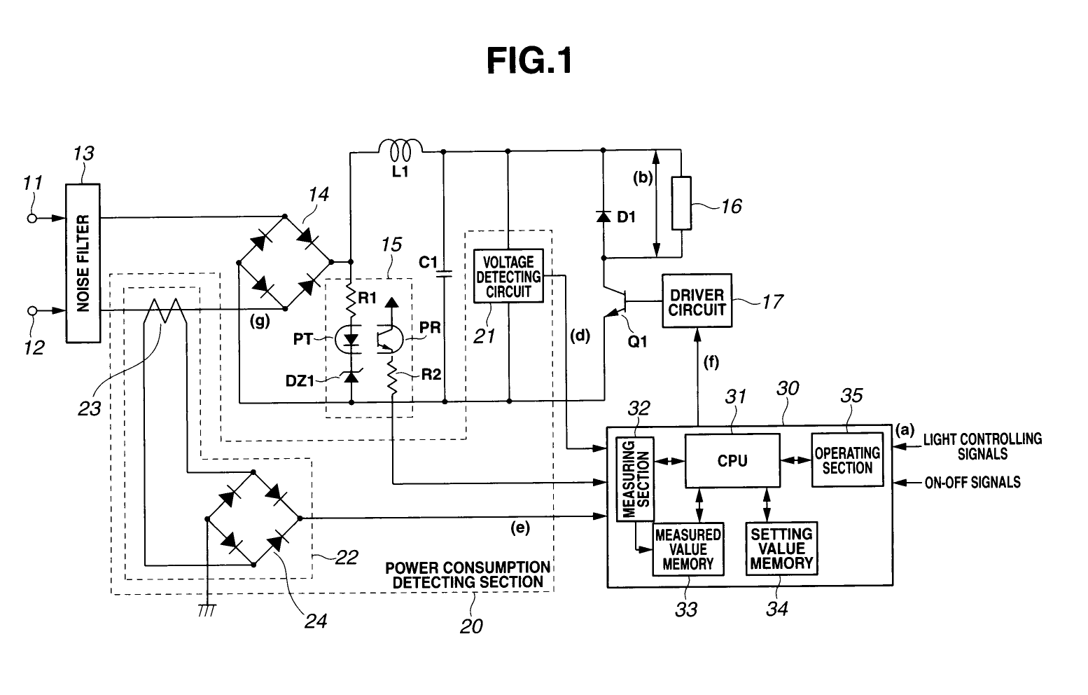

An embodiment of the present invention will be described below in detail referring to the drawings. FIG. 1 is a circuit diagram showing a fixer driving device according to a first embodiment of the present invention.

In the present embodiment, an example wherein the heater of a fixer of a copying machine is composed of a load lamp 16 will be described.

In FIG. 1, an alternate current power source voltage from, for example, an alternate current power source is supplied between power source terminals 11 and 12. The power source voltage supplied via the power source terminals 11 and 12 is supplied to a noise filter 13. The noise filter 13 removes the noise component of the supplied power source voltage. A rectifier 14 is connected between the output ends of the noise filter 13. The rectifier 14 is a full-wave rectifier composed of, for example, diode bridges.

A noise filter composed of a filter choke L1 and a capacitor C1 is installed between the output ends of the rectifier 14. A pulsating flow voltage wherein noise is removed from the full-wave rectified from the rectifier 14 is generated between the both ends of the capacitor C1.

A serial circuit composed of a diode D1 and a switching transistor Q1 is connected in parallel between the both ends of the capacitor C1. The load lamp 16 is connected in parallel between the both ends of the diode D1. The transistor Q1 is controlled by a driver circuit 17, and is turned on and turned off at a specified duty ratio. Specifically, the voltage applied to the load lamp 16 is turned on and off corresponding to on and off of the transistor Q1, and an effective voltage corresponding to the on-duty of the transistor Q1 is supplied to the load lamp 16.

In the present embodiment, feedback control by a power consumption detecting section 20 and a controlling section 30 is performed for the constant power control of the load lamp 16. The power consumption detecting section 20 is composed of a voltage detecting circuit 21 and a current detecting circuit 22. The voltage detecting circuit 21 smoothes voltage between the both ends of the capacitor C1 so as to output to the controlling section 30 as a detected voltage.

The current detecting circuit 22 detects current flowing to the input side of the rectifier 14. Specifically, the current detecting circuit 22 has a current transformer 23 and a rectifier 24 installed on a wiring between the noise filter 13 and the rectifier 14. The current transformer 23 detects current flowing to the input side of the rectifier 14, and the rectifier 24 transforms the alternate current detected by the current transformer 23 to a direct current. The current detected by the current detecting circuit 22 is supplied to the controlling section 30.

A measuring section 32 in the controlling section 30 measures the detected voltage and detected current from the power consumption detecting section 20 to obtain the power consumption of the load lamp 16. Although the detected voltage and detected current of the power consumption detecting section 20 is the sum of the power consumption of the load lamp 16 and the circuit loss, since the circuit loss is normally known, the measuring section 32 can obtain the power consumption of the load lamp 16 from the output of the power consumption detecting section 20 and the known circuit loss.

In the present embodiment, the controlling section 30 obtains the measuring timing of power consumption, and utilizes the output of a zero-cross detecting section 15 to obtain the controlling timing of the transistor Q1 as described later. The zero-cross detecting section 15 is connected between the output ends of the rectifier 14, and is composed of resistors R1 and R2, the light-emitting section PT and the light receiving section PR of a photo coupler, and a zener diode DZ1. The light-emitting section PT of the photo coupler emits light when the voltage between the output ends of the rectifier 14 is within the specific level range specified by the zener diode DZ1. The light receiving section PR of the photo coupler is conducted when the iight-emitting section PT of the photo coupler emits light, and supplies detected signals to the controlling section 30 via the resistor R2.

As described above, the output of the rectifier 14 is a pulsating flow. The zero-cross detecting section 15 outputs zero-cross detecting signals to the controlling section 30 when the output of the rectifier 14 becomes a value in the vicinity of zero cross, in other words, every half cycle of the alternate current power source voltage.

The controlling section 30 has a CPU 31, and the CPU 31 controls respective components of the controlling section 30. The CPU 31 controls the measuring section 32 to measure the power consumption of the load lamp 16 at a plurality of timings within the half cycle of the alternate current power source voltage, with reference to the zero-cross timing. For example, the CPU 31 controls the measuring section 32 to measure the power consumption at every sampling timing from the detected voltage and the detected current at sampling timings in every several millisecond from the zero-cross timing.

In the present embodiment, the CPU 31 once supplies the measured result of power consumption to a measured value memory 33 so as to store the result. The measured value memory 33 can store the values of power consumption at least at the sampling timing of the half cycle of the alternate current power source voltage.

The CPU 31 reads the values of power consumption obtained in the specific half cycle of the alternate current power source voltage from the measured value memory 33, and supplies the read values to an operating section 35 so as to compute the control quantity of PWM control in the following half cycle. The operating section 35 obtains the control quantity (setting value) for setting the on-duty of the transistor Q1 on the basis of power consumption obtained in a specified half cycle of the alternate current power source voltage, for example, the mean value, and power consumption corresponding to the light controlling signals. The light controlling signals may be signals digitally indicating the setting temperature, or may be signals analogically indicating the setting temperature.

In the present embodiment, the operating section 35 fixedly computes the setting values in a half cycle following a specified half cycle of the alternate current power source voltage. The CPU 31 stores the computed control quantity (setting value) in a setting value memory 34, and supplies the control quantity to the driver circuit 17 in the following half cycle as PWM control signals. The driver circuit 17 sets the on-duty of the transistor Q1 on the basis of the PWM control signals supplied from the controlling section 31. Thereby, in the present embodiment, the on-duty of the transistor Q1 is fixed during the half cycle of the alternate current power source voltage.

The CPU 31 performs the computation of power consumption and the computation of the control quantity of PWM control in each half cycle of the alternate current power source voltage, and changes setting values every half cycle. To the controlling section 30, ON-OFF signals for indicating ON and OFF of the load lamp 16 are also supplied.

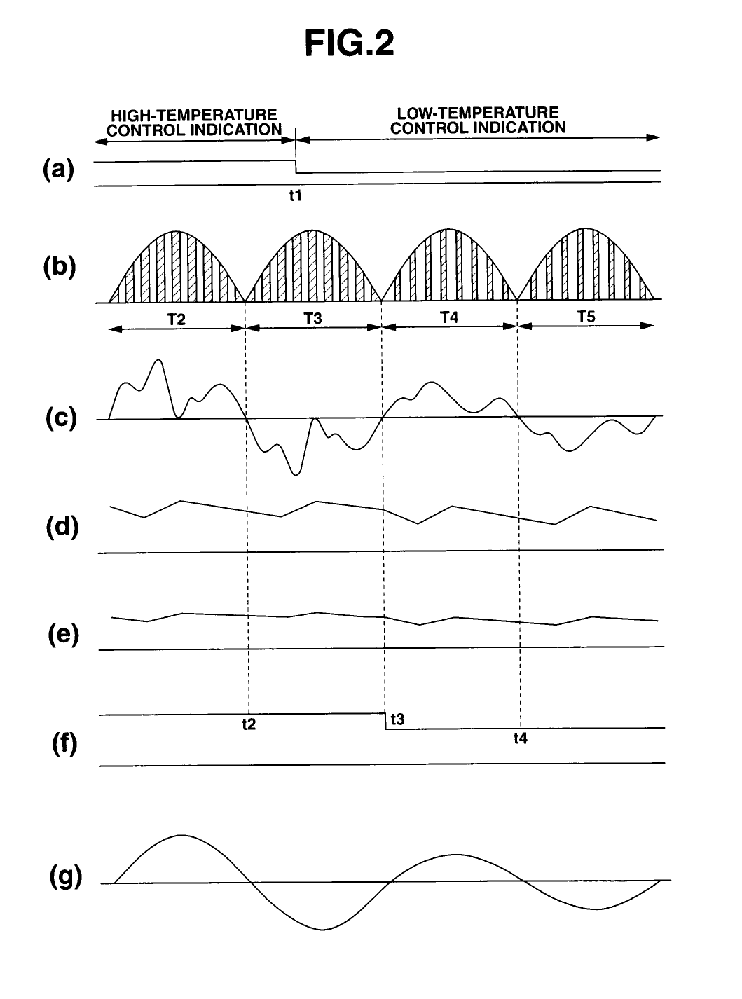

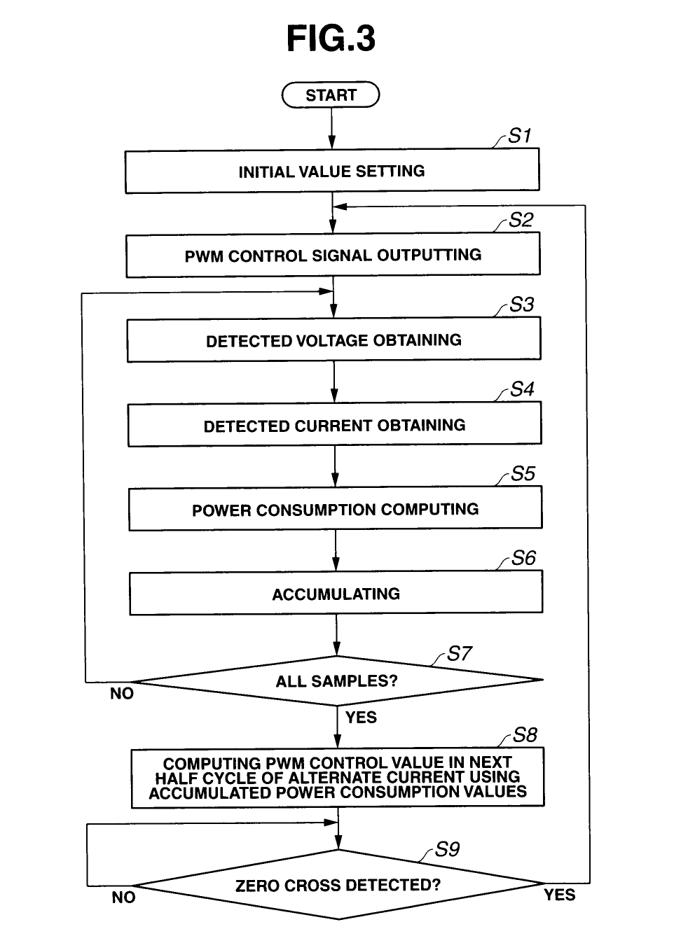

Next, the operation of thus composed embodiment will be described referring to FIGS. 2 and 3. FIG. 2 is a waveform diagram showing the signal waveform of respective sections. FIGS. 2(a), (b), and (d) to (g) show signal waveforms at (a), (b), and (d) to (g) in FIG. 1, respectively. FIG. 2(c) shows the variation of current in the input side of the rectifier 14 when PWM control is sequentially performed corresponding to the smoothed lamp voltage in the same manner as in conventional examples. FIG. 3 is a flowchart for illustrating constant power consumption control in the present embodiment.

The alternate current power source voltage supplied from power source terminals 11 and 12 the noise of which is removed by the noise filter 13 is supplied to the rectifier 14. The rectifier 14 converts alternate current into a pulsating voltage by full-wave rectification. Noise in the output of the rectifier 14 is removed by the filter choke L1 and the capacitor C1. Thereby, a pulsating flow voltage, which is a rectified output of the alternate current power source voltage, is generated between the both ends of the capacitor C1. The envelope curve in FIG. 2(b) shows the pulsating flow applied to the load lamp 16.

Here, ON is indicated by the ON-OFF signal. In Step S1 in FIG. 3, the CPU 31 sets an initial value for P WM control, and outputs the set initial value to the driver circuit 17 as the PWM control signal in Step S2. Thereby, the driver circuit 17 drives the transistor Q1 in a specified on-duty. Specifically, the pulsating flow voltage between the both ends of the capacitor C1 is intermitted by the transistor Q1, and rectangular-wave voltage is applied to the load lamp 16.

The control quantity of PWM control corresponds to the on-duty of the transistor Q1. For example, the load lamp 16 is assumed to consume 1 kW power at full lighting, and the initial value of the on-duty is assumed to be 100%. In the standby state, the initial value of the on-duty is assumed to be 0 to 20% to set, for example, 0 to 100 W as the power consumption of the load lamp 16. When the light-controlling quantity is a value between the standby state and full lighting, the CPU 31 varies on-duty linearly depending on power consumption corresponding to the light controlling signal.

In this case, as shown in the high-temperature control indication in the first half of FIG. 2(a), a light controlling signal to make the temperature generated by the load lamp 16 relatively high is assumed to be supplied. In this case, the driver circuit 17 drives the transistor Q1 at a relatively large on-duty.

The diagonal-line region of FIG. 2(b) shows the ON period of the transistor Q1, and shows the voltage applied to the load lamp 16. The ON-OFF frequency of the transistor Q1 is about 20 to 100 kHz.

The voltage detecting circuit 21 smoothes the voltage in the diagonal-line region, and generates detected voltage shown in FIG. 2(d). On the condition that PWM control is performed using only the detected voltage and sequentially varies the on-duty of the transistor Q1 as described in Patent Document 1, the on-duty is lowered in the high-voltage period, and the on-duty is elevated in the low-voltage period, resulting in the deformation of the current flowing in the rectifier 14 as shown in FIG. 2(c). Then, the power factor of the circuit is lowered, and it takes a long time until the temperature generated by the load lamp 16 reaches a specified setting temperature.

Whereas in the present embodiment, by varying the control quantity of PWM control in every period of a half cycle of the alternate current power source voltage, the power factor of the circuit is improved. Alternatively, not only by detecting the voltage applied to the load lamp 16, but also by detecting the current flowing in the rectifier 14, control corresponding to the power consumption of the load lamp 16 is made possible, and the accuracy of the PWM control is improved.

Specifically, the CPU 31 uses the zero-cross detecting signals from the zero-cross detecting section 15 to acquire the zero-cross timing of the voltage applied to the load lamp 16. Next, the CPU 31 sets a plurality of sampling timings in a half cycle of the alternate current voltage inputted in the rectifier 14 with reference to the zero-cross timing. Then, the CPU 31 controls the measuring section 32, and computes the power consumption of the load lamp 16 from the detected voltage of the voltage detecting circuit 21 and the detected current of the current detecting circuit 22 in each sampling timing.

The CPU 31 acquires the detected voltage from the voltage detecting circuit 21 in Step S3, and acquires the detected current from the current detecting circuit 22 in Step S4. Then in Step S5, the power consumption is computed form the product of the detected voltage and the detected current, and further the power consumption of the load lamp 16 is obtained by deducting the known circuit loss.

The CPU 31 supplies the computed data of power consumption to the measured value memory 33 to make the memory 33 store the data (Step S6). The CPU 31 repeats the processes of Steps S3 to S6 until power consumption in all the sampling timings is obtained. When power consumption in all the sampling points is obtained, the process is shifted to Step S8.

In Step S8, the CPU 31 controls the operating section 35, and computes the control quantity of the PWM control set in a half cycle of the alternate current power source voltage. For example, the CPU 31 obtains the mean value of power consumption in a half cycle of the alternate current voltage, and the difference from power consumption specified corresponding to the light controlling signals, and obtains the control quantity corresponding to the difference. The data of the control quantity (setting value) is stored in the setting value memory 34 as the PWM control value.

In Step S9, the CPU 31 detects zero cross. The zero-cross detecting section 15 outputs the zero-cross detecting signal in the zero-cross timing of the output from the rectifier 14, and the CPU 31 detects the switching timing of a half cycle of the alternate current power source voltage by the zero-cross detecting signal. When the CPU 31 detects zero cross, the CPU 31 returns the process to Step S2, and read the PWM control value computed in Step S8 to supply the PWM control value to the driver circuit 17.

For example, when zero cross is detected in the timing t2 in FIG. 2, the PWM control value computed on the basis of the detected voltage and the detected current collected in the period T2 in FIG. 2 is fixedly supplied to the driver circuit 17. Thus in the period T3, which in a next half cycle, the driver circuit 17 drives the transistor Q1 at a fixed on-duty on the basis of the PWM control value computed using the power consumption in the period T2. Thereby, the transistor Q1 is driven at the fixed on-duty without changing the on-duty in the period of a half cycle of the alternate current power source voltage. In FIG. 2, substantially the same examples are shown for the on-duties in the periods T2 and T3.

In the example shown in FIG. 3, although an example for the controlling section 31 wherein the computation of the power consumption of the load lamp 16 and the computation of the control quantity of PWM control are performed in a time sharing manner in a half cycle of the alternate current power source voltage is shown, these processes may be simultaneously performed in parallel. Thereby, the controlling section 31 changes the control quantity of PWM control in every half cycle of the alternate current power source voltage.

When the generated temperature set in the load lamp 16 is changed, in other words, when the light controlling signal is changed, change in the control quantity of PWM control is performed in every half cycle of the alternate current power source voltage. For example, as shown in FIG. 2(a), when the light controlling signal is changed in the timing t1 during a specified half cycle of the alternate current power source voltage, the PWM control corresponding the light controlling signal is changed in the starting timing t3 of the next half cycle of the alternate current power source voltage as shown in FIG. 2(f). With respect to the low-temperature control indication of the light controlling signal, actual low-temperature control is performed in the period T4 or later.

In the present embodiment, as described above, the control quantity of PWM control changes in every half cycle of the alternate current power source voltage. In the half cycle of the alternate current power source voltage, the control quantity of PWM control is fixed, and change in the current flowing in the rectifier 14 is constant. Specifically, as shown in FIG. 2(g), a current having a sinusoidal waveform flows in the rectifier 14. Thereby, the power factor of the circuit can be improved, and a lamp driver circuit with a high efficiency can be composed. Thus, for example, even when the load lamp 16 is shifted from the standby state of off-lighting to the lighting state, a high-output use becomes possible, and a desired setting temperature can be reached in a short time.

1. A fixer driving device comprising:
a rectifier for rectifying an alternate current power source voltage;
a power supplying section for supplying the output of the rectifier to a load lamp;
a power consumption detecting section for detecting power consumption of the load lamp;
a control quantity computing section for computing control quantity for the power supplying section in order to supply a constant electric power to the load lamp on a basis of the detection result by the power consumption detecting section; and
a controlling section for fixedly setting the control quantity computed by the control quantity computing section to the power supplying section in a specified cycle.

2. The fixer driving device according to claim 1, wherein
the controlling section fixedly sets the control quantity computed by the control quantity computing section to the power supplying section in a half cycle of the alternate current power source voltage.

3. The fixer driving device according to claim 1, wherein
the power consumption detecting section comprises:
a voltage detecting section for detecting the voltage supplied to the load lame; and
a current detecting section for detecting a current flowing in the rectifier on the input side of the rectifier.

4. The fixer driving device according to claim 3, wherein
the power consumption detecting section obtains the power consumption of the load lamp from the product of supplied voltage in the load lamp detected by the voltage detecting section and the current on the input side of the rectifier detected by the current detecting section, and a known circuit loss.

5. The fixer driving device according to claim 2, wherein
the controlling section specifies a period of the half cycle of the alternate current power source voltage with reference to the zero cross timing of the alternate current power source voltage.

6. The fixer driving device according to claim 2, wherein
the power consumption detecting section and the control quantity computing section detect the power consumption of the load lamp and compute the control quantity in the period of the half cycle of the alternate current power source voltage with reference to the zero cross timing of the alternate current power source voltage; and
the controlling section fixedly sets the control quantity to the power supplying section in the period of a half cycle following the period of the half cycle when the power consumption detecting section and the control quantity computing section detect the power consumption and compute the control quantity.

7. The fixer driving device according to claim 6, wherein
the control quantity computing section sets a plurality of sampling timings in a half cycle of the alternate current power source voltage; obtains a mean value of power consumption in each sampling timing; obtains the difference between the obtained mean value of power consumption and the power consumption specified corresponding to the light controlling signal that determines the light control quantity of the load lamp; and obtains the control quantity corresponding to the difference.

8. The fixer driving device according to claim 1, wherein
the electric power supplying section has a switching element for intermittently supplying the output of the rectifier to the load lamp; and
the controlling section controls the light from the load lamp by changing the on-duty of the switching element on the basis of the control quantity.

9. A fixer driving device comprising:
a first rectifier for rectifying an alternate current power source voltage;
a capacitor for smoothing the output of the first rectifier;
an electric power supplying section composed of a diode and a switching transistor connected to the output end of the capacitor, for intermittently supplying the voltage generated in the capacitor to the both ends of the diode;
a load lamp connected in parallel to the diode, the load lamp being supplied with electric power from the electric power supplying section;
a driver for driving the switching transistor;
a voltage detecting section for detecting the terminal voltage of the capacitor;
a current detecting section composed of a current transformer and a second rectifier connected to the input side of the first rectifier, which detects current flowing to the input side of the first rectifier;
a control quantity computing section for computing the control quantity for the switching transistor of the electric power supplying section on the basis of the output of the voltage detecting section and the current detecting section; and
a controlling section for fixedly setting the on-duty of the switching transistor of the electric power supplying section in a half cycle of the alternate current power source voltage by controlling the driver on the basis of the control quantity computed by the control quantity computing section.

10. The fixer driving device according to claim 9 further comprising a zero-cross detecting section having a photo coupler and a zener diode connected to the output end of the first rectifier, for detecting the timing when the output of the first rectifier constitutes zero cross; wherein
the controlling section determines the on-duty of the switching transistor in a half cycle of the alternate current power source voltage with reference to the detection result of the zero-cross detecting section.

11. A fixer driving method for controlling the light from the load lamp by intermittently supplying the output of the rectifier of an alternate current power source voltage to a load lamp with a switching transistor, and by the PWM control of the on-duty of the switching transistor, comprising:
a step for setting the initial value of the PWM control;
a step for acquiring the power consumption of the load lamp; and
a step for fixedly setting the control value of the PWM control in a half cycle of the alternate current power source voltage on the basis of power consumption of the load lamp.

12. The fixer driving method according to claim 11, wherein
the step for acquiring the power consumption of the load lamp acquires the power consumption in a specified half cycle of the alternate current power source voltage; and
the step for fixedly setting the control value of the PWM control fixedly sets the control value of the PWM control in a half cycle following the specified half cycle on the basis of the power consumption acquired in the specified half cycle.
